(19) United States
(12) Patent Application Publication
(10) Pub. No.: US 2022/0101663 A1
(43) Pub. Date: Mar. 31, 2022

(54) DRIVING EVALUATION DEVICE, DRIVING EVALUATION SYSTEM, AND RECORDING MEDIUM

(71) Applicant: TOYOTA JIDOSHA KABUSHIKI KAISHA, Toyota-shi (JP)

(72) Inventors: Kenki UEDA, Tokyo-to (JP); Ryosuke TACHIBANA, Tokyo-to (JP); Shinichiro KAWABATA, Tokyo-to (JP); Takashi KITAGAWA, Tokyo-to (JP); Hirofumi OHASHI, Tokyo-to (JP); Toshihiro YASUDA, Osaka-shi (JP); Tetsuo TAKEMOTO, Toyko-to (JP)

(73) Assignee: TOYOTA JIDOSHA KABUSHIKI KAISHA, Toyota-shi (JP)

(21) Appl. No.: 17/390,046

(22) Filed: Jul. 30, 2021

(30) Foreign Application Priority Data
Sep. 25, 2020 (JP) 2020-161406

(51) Int. Cl. G07C 5/08

(52) U.S. Cl. CPC G07C 5/0808; G07C 5/0866

(57) ABSTRACT

A driving evaluation device that acquires dangerous driving detection results for a plurality of vehicles and characteristic information indicating supplementary characteristics for at least one of a driver characteristic or an environmental characteristic; and groups the acquired dangerous driving detection results according to the characteristic information, and derives a relative driving evaluation result for each driver of the plurality of vehicles, based on the grouped detection results.

### CROSS-REFERENCE TO RELATED APPLICATION

This application is based on and claims priority under 35 USC 119 from Japanese Patent Application No. 2020-161406 filed on Sep. 25, 2020, the disclosure of which is incorporated by reference herein.

### BACKGROUND

### Technical Field

The present disclosure relates to a driving evaluation device, a driving evaluation system, and a computer-readable non-transitory recording medium recorded with a driving evaluation program to evaluate driving by a driver.

### Related Art

Japanese Patent Application Laid-Open (JP-A) No. 2016-197308 discloses a driving diagnostic device configured to generate and output on-screen information including a diagnostic result for dangerous driving behavior of a target driver, and also distributions of a safe driver group and a dangerous driver group as determined using driver travel history information stored in a storage section. These distributions are expressed with a horizontal axis representing a degree of dangerous driving behavior by a driver, and a vertical axis representing the number of drivers corresponding to this degree of dangerous driving behavior.

Although the generated on-screen information enables a driver to ascertain their own diagnostic result with respect to the distribution of diagnostic results of other drivers, no consideration is given to supplementary characteristics, for example driver characteristics including type of vehicle driven, age, gender, place of residence, years of driving experience, or the like, nor to environmental characteristics when driving (such as weather, time of day, or the like). A user may therefore feel that the diagnostic result is unsatisfactory, leaving room for improvement in this respect.

### SUMMARY

An aspect of the present disclosure is a driving evaluation device that includes: a memory; and a processor coupled to the memory. The processor is configured to: acquire dangerous driving detection results for a plurality of vehicles and characteristic information indicating supplementary characteristics for at least one of a driver characteristic or an environmental characteristic; and group the acquired dangerous driving detection results according to the characteristic information, and derive a relative driving evaluation result for each driver of the plurality of vehicles, based on the grouped detection results.

### BRIEF DESCRIPTION OF DRAWINGS

FIG. 1 is a diagram illustrating a schematic configuration of a dangerous driving detection system according to one implementation of an exemplary embodiment.

FIG. 2 is a functional block diagram illustrating a functional configuration of an onboard device and a dangerous driving data gathering server of a dangerous driving detection system according to one implementation of an exemplary embodiment.

FIG. 3 is a block diagram illustrating configuration of a control section of an onboard device and a central processing device of a dangerous driving data gathering server.

FIG. 4 is a block diagram illustrating a functional configuration of a dangerous driving evaluation section.

FIG. 5 is a diagram illustrating an example of a normal distribution.

FIG. 6 is a diagram illustrating an example of a derivation method for a converted score from a deviation score of an evaluation score.

FIG. 7 is a diagram illustrating an example of frequencies, deviation scores, and converted scores for tailgating for individual drivers.

FIG. 8 is a diagram illustrating an example of presentation of a relative driving evaluation result for a driver to the driver.

FIG. 9 is a flowchart illustrating an example of a flow of processing performed using the functionality of a dangerous driving evaluation section of a central processing device of a dangerous driving data gathering server in a dangerous driving detection system according to one implementation of an exemplary embodiment.

### DETAILED DESCRIPTION

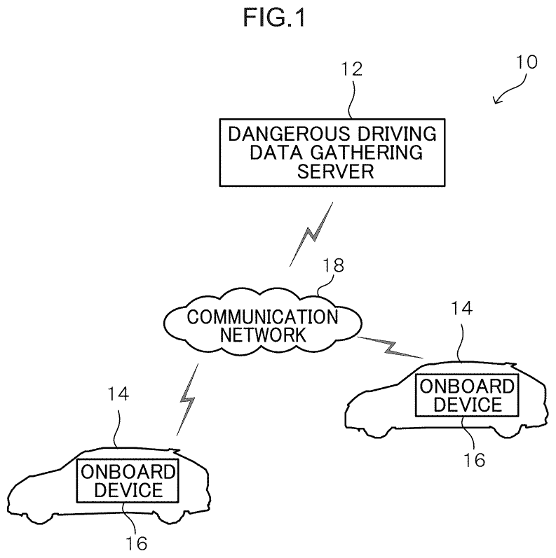

Detailed explanation follows regarding an example of an exemplary embodiment of the present disclosure, with reference to the drawings. FIG. 1 is a diagram illustrating a schematic configuration of a dangerous driving detection system according to the present exemplary embodiment.

In a dangerous driving detection system 10 according to the present exemplary embodiment, onboard devices 16 installed in vehicles 14 are connected to a dangerous driving data gathering server 12 over a communication network 18. In the dangerous driving detection system 10 according to the present exemplary embodiment, image information captured by the plural onboard devices 16 and vehicle information expressing states of the respective vehicles 14 are transmitted to the dangerous driving data gathering server 12, and the dangerous driving data gathering server 12 compiles this image information and vehicle information. The dangerous driving data gathering server 12 also performs driver evaluation processing and the like.

Each of the onboard devices 16 of the present exemplary embodiment performs processing to detect dangerous driving by an occupant, and dangerous driving detection results are transmitted to the dangerous driving data gathering server 12. The dangerous driving data gathering server 12 gathers the dangerous driving detection results from each of the vehicles 14 and performs driver evaluation processing based on the gathered dangerous driving detection results.

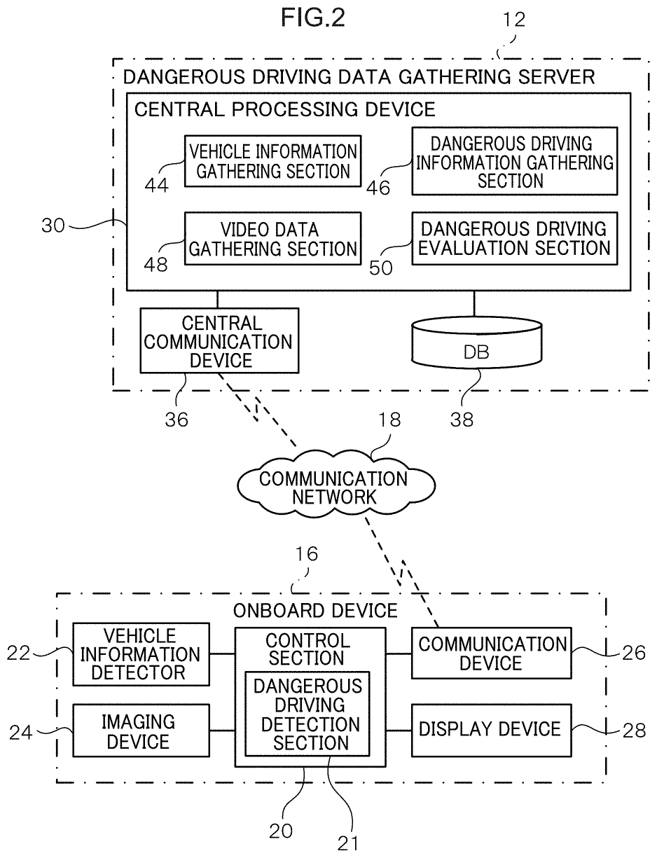

FIG. 2 is a functional block diagram illustrating functional configurations of the onboard device 16 and the dangerous driving data gathering server 12 of the dangerous driving detection system 10 according to the present exemplary embodiment.

Each of the onboard devices 16 includes a control section 20, a vehicle information detector 22, an imaging device 24, a communication device 26, and a display device 28.

The vehicle information detector 22 detects vehicle information relating to the corresponding vehicle 14. Examples of the vehicle information detected include position information, a vehicle speed, acceleration, steering angle, accelerator pedal position, distances to obstacles in the vehicle surroundings, a route, and so on of the vehicle 14. More precisely, plural types of sensors and other devices may be applied as the vehicle information detector 22 in order to acquire information expressing a situation in the surrounding environment of the vehicle 14. Examples of such sensors and other devices include sensors such as a vehicle speed sensor and an acceleration sensor installed in the vehicle 14, a global navigation satellite system (GNSS) device, an onboard transceiver, a navigation system, and a radar device. The GNSS device measures the position of an ego vehicle 14 by receiving GNSS signals from plural GNSS satellites. The precision of the positioning by such a GNSS device improves the greater the number of GNSS signals that can be received. The onboard transceiver is a communication device that performs at least one out of vehicle-to-vehicle communication between respective vehicles 14 or roadside-to-vehicle communication with roadside equipment via the communication device 26. The navigation system includes a map information storage section stored with map information, and performs processing to display the position of the ego vehicle 14 on a map and provide guidance along a route to a destination based on position information acquired from a GNSS device and the map information stored in the map information storage section. The radar device includes plural radars with different detection ranges, and detects objects such as pedestrians and other vehicles 14 present in the surroundings of the ego vehicle 14, and acquires relative positions and relative speeds of such detected objects with respect to the ego vehicle 14. Such a radar device includes an inbuilt processor to process scan results for such surrounding objects. The processor eliminates noise and roadside objects such as guardrails from monitoring targets based on changes in the relative positions and relative speeds of individual objects included in plural recent scan results, and tracks and monitors pedestrians, other vehicles 14, and the like as monitoring targets. The radar device also outputs information such as the relative positions and relative speeds of the individual monitoring targets. Note that in the present exemplary embodiment, at least the vehicle speed is detected as vehicle information.

In the present exemplary embodiment, the imaging devices 24 are installed in the respective vehicles 14 so as to image the vehicle surroundings, for example in front of the corresponding vehicle 14, and generate video image data expressing captured video images as image information. A camera such as a drive recorder may be applied as the imaging device 24. Note that the imaging device 24 may also image the vehicle surroundings to at least one out of the sides or rear of the corresponding vehicle 14. The imaging device 24 may also capture a vehicle cabin interior.

The communication device 26 establishes communication with the dangerous driving data gathering server 12 over the communication network 18, and transmits and receives information including image information captured by the imaging device 24 and vehicle information detected by the vehicle information detector 22.

The display device 28 may be a presenter, for example, a liquid crystal display, that displays information in order to present various information to an occupant. In the present exemplary embodiment, the display device 28 may, for example, display information provided by the dangerous driving data gathering server 12.

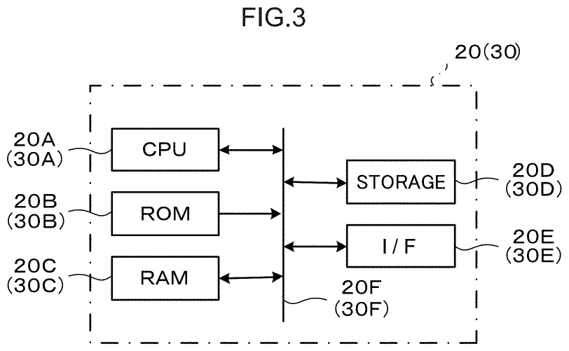

As illustrated in FIG. 3, the control section 20 is configured by a microcomputer including a central processing unit (CPU) 20A, serving as an example of a hardware processor, read only memory (ROM) 20B, serving as an example of memory, random access memory (RAM) 20C, storage 20D, an interface (I/F) 20E, and a bus 20F. A graphics processing unit (GPU) may be employed instead of the CPU.

The CPU 20A of the control section 20 uses the RAM 20C to load and execute a program held in the ROM 20B in order to implement the functionality of a dangerous driving detection section 21. The control section 20 also performs control to upload image data of video images expressing images captured by the imaging device 24, and vehicle information detected by the vehicle information detector 22 at the time of this image capture, to the dangerous driving data gathering server 12. Note that when uploading the image information and the vehicle information, identification information to identify an individual vehicle and an individual driver is appended before transmitting. For example, this driver identification information may be a captured image of the driver, may be identification information for a smart key carried by the driver, or may be other information that enables identification of the driver.

The program may, for example, be recorded on a non-transitory computer readable recording medium such as a HDD, SSD, or DVD and loaded and executed by the CPU 20A using the RAM 20C.

The dangerous driving detection section 21 detects various types of dangerous driving by the driver based on the detection results of the vehicle information detector 22 and captured images captured by the imaging device 24. The various types of dangerous driving detected by the dangerous driving detection section 21 include, for example, predefined sudden operations of operation controls, obstruction of pedestrians, excessive speed, tailgating, that is, not keeping a distance between vehicles, missed traffic signals, missed mandatory stops, and distracted driving. Examples of predefined sudden operations of operation controls include sudden acceleration, sudden braking, and sudden steering wheel operation. For example, sudden acceleration may be detected in cases in which acceleration to increase speed or an operation speed of an accelerator pedal is a predetermined threshold value or greater. Sudden braking may be detected in cases in which deceleration to reduce speed or a force applied to a brake pedal is a predetermined threshold value or greater. Sudden steering wheel operation may be detected in cases in which a change in steering angle or acceleration in a vehicle width direction is a predetermined threshold value or greater. Obstruction of a pedestrian may be detected by, for example, determining whether or not a mandatory stop is performed when a pedestrian has been detected close to a pedestrian crossing in a captured image. Excessive speed may be detected by, for example, detecting speed limit signs from captured images and determining whether or not the vehicle speed is greater than the speed limit. Tailgating may be detected by, for example, detecting a distance to a vehicle ahead from captured images, and determining whether or not this is within a predetermined distance. Missed traffic signals may, for example, be detected based on captured images. Missed mandatory stops may be detected by, for example, detecting a mandatory stopping position from captured images and determining whether or not a complete stop is performed at the mandatory stopping position. Distracted driving may, for example, be detected based on captured images from an in-cabin camera.

The dangerous driving data gathering server 12 includes a central processing device 30, a central communication device 36, and a database (DB) 38.

As illustrated in FIG. 3, the central processing device 30 is configured by a microcomputer including a CPU 30A, ROM 30B, RAM 30C, storage 30D, an interface (I/F) 30E, a bus 30F, and the like.

The CPU 30A of the central processing device 30 uses the RAM 30C to load and execute a program held in the ROM 30B in order to function as a vehicle information gathering section 44, a dangerous driving information gathering section 46, a video data gathering section 48, and a dangerous driving evaluation section 50.

The vehicle information gathering section 44 gathers vehicle information detected by the respective onboard devices 16 of the plural vehicles 14 and performs processing to compile this vehicle information in the DB 38. Information detected by the various sensors and the like installed in the vehicles 14 is gathered as the vehicle information.

The dangerous driving information gathering section 46 gathers dangerous driving information detected by the respective onboard devices 16 of the plural vehicles 14 and performs processing to compile this vehicle information in the DB 38. Information regarding the type of dangerous driving, as well as the date and time, is gathered as the dangerous driving information. In the present exemplary embodiment, the types of dangerous driving gathered as dangerous driving include sudden acceleration, sudden braking, sudden steering wheel operation, obstruction of pedestrians, excessive speed, tailgating, missed traffic signals, missed mandatory stops, distracted driving, and the like.

The dangerous driving evaluation section 50 performs processing to evaluate the driving of each individual driver based on the dangerous driving information gathered by the dangerous driving information gathering section 46. Note that the dangerous driving evaluation section 50 will be described in detail later.

The video data gathering section 48 performs processing to gather video image data captured by the respective onboard devices 16 of the plural vehicles 14 as image information, and compiles this image information in the DB 38.

The central communication device 36 establishes communication with the onboard device 16 over the communication network 18, and transmits and receives information including image information, vehicle information, and the like.

The DB 38 compiles driver characteristic information relating to pre-registered drivers and information relating to vehicles in association with identification information to identify each of the drivers and each of the vehicles. Examples of driver characteristic information in the present exemplary embodiment include characteristic information expressing driver characteristics such as type of vehicle driven, age, gender, place of residence, and years of driving experience. This characteristic information is compiled as supplementary information for each of the drivers. The driver characteristic information and the identification information identifying each driver and each vehicle is, for example, recorded by the onboard device 16 when a user registers for a driving evaluation service provided by the dangerous driving data gathering server 12, or by the driver operating various types of information processing device (such as a personal computer or mobile terminal) operated by the driver.

The DB 38 compiles the vehicle information gathered by the vehicle information gathering section 44, the video image data gathered by the video data gathering section 48, and the dangerous driving information gathered by the dangerous driving information gathering section 46 in association with the identification information identifying each vehicle and each driver.

The dangerous driving data gathering server 12 performs driver evaluation processing and the like based on the compiled information in the DB 38. The dangerous driving data gathering server 12 then provides various services, such as a service to feed back driving evaluation results to the respective drivers.

Note that in the present exemplary embodiment, explanation is given regarding a configuration in which dangerous driving detection is performed by the onboard devices 16. However, dangerous driving detection may be performed by the dangerous driving data gathering server 12, or dangerous driving detection may be performed by another server.

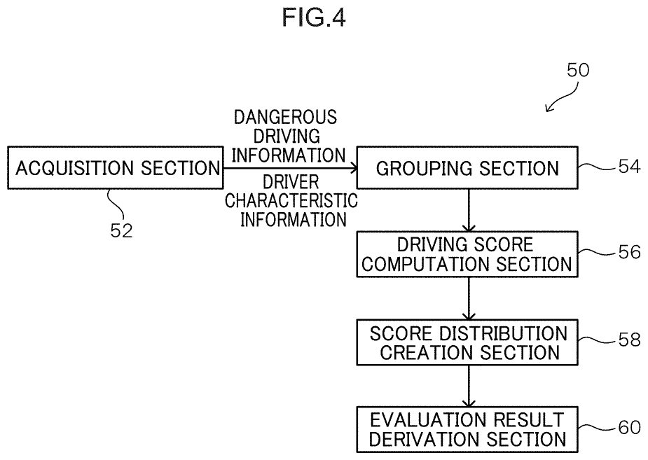

Next, detailed explanation follows regarding functional configuration of the dangerous driving evaluation section 50 of the central processing device 30 of the dangerous driving data gathering server 12. FIG. 4 is a block diagram illustrating functional configuration of the dangerous driving evaluation section 50.

The dangerous driving evaluation section 50 includes the functionality of an acquisition section 52, a grouping section 54, a driving score computation section 56, a score distribution creation section 58, and an evaluation result derivation section 60. Note that the grouping section 54, the driving score computation section 56, the score distribution creation section 58, and the evaluation result derivation section 60 correspond to an example of a derivation section.

The acquisition section 52 acquires the dangerous driving information and driver characteristic information gathered by the dangerous driving information gathering section 46 and held in the DB 38. Examples of the acquired dangerous driving information include dangerous driving information expressing detection results for sudden acceleration, sudden braking, sudden steering wheel operation, obstruction of pedestrians, excessive speed, tailgating, missed traffic signals, missed mandatory stops, distracted driving, and the like. Examples of the acquired driver characteristic information include characteristic information expressing driver characteristics such as the type of vehicle driven, age, gender, place of residence, years of driving experience, and the like.

Based on the driver characteristic information, the grouping section 54 groups the dangerous driving information acquired by the acquisition section 52 according to the driver characteristics, such as type of vehicle driven, age, gender, place of residence, years of driving experience, and the like. Note that in addition to the driver characteristics, grouping may also be performed according to environmental characteristics such as the time of day and weather when driving. Alternatively, grouping may be performed so as to combine both driver characteristics and environmental characteristics.

The driving score computation section 56 computes a dangerous driving incident frequency as a dangerous driving score for each driver based on the dangerous driving information for each group as grouped by the grouping section 54. The frequency is computed either as a number of dangerous driving incidents per unit distance traveled (frequency by distance) or a number of dangerous driving incidents per unit time (frequency by time). Note that the frequency by distance and frequency by time may both be computed. In such cases, whether the frequency by distance or frequency by time is employed may be switched in accordance with circumstances, for example the distance traveled or the time traveled. For example, a switch to employ the frequency by time may be made in cases in which the distance traveled is short, and a switch employ to the frequency by distance may be made in cases in which the distance traveled is longer than average. Switching between frequency by distance and frequency by time in accordance with circumstances enables a driving evaluation result better suited to the circumstances to be obtained.

The score distribution creation section 58 creates a dangerous driving score distribution covering all drivers in each group as grouped by the grouping section 54.

The evaluation result derivation section 60 derives a deviation score as an evaluation score in order to evaluate the score of each driver with respect to the dangerous driving score distribution covering all drivers in each group as grouped by the grouping section 54. The evaluation result derivation section 60 also employs a predetermined method to convert the derived evaluation score to a converted score in order to derive a relative driving evaluation result for each driver. Note that the evaluation result derivation section 60 may derive an evaluation score alone, without deriving a converted score. The evaluation score is a scored evaluation for each driver with respect to the dangerous driving score distribution of all drivers. Deriving the evaluation score thereby enables a relative driving evaluation result to be derived for each driver. Accordingly, a relative driving evaluation result for each driver can be derived even when the converted score is derived from the evaluation score.

Detailed explanation follows regarding an example of a derivation method used by the evaluation result derivation section 60 to derive the driving evaluation result.

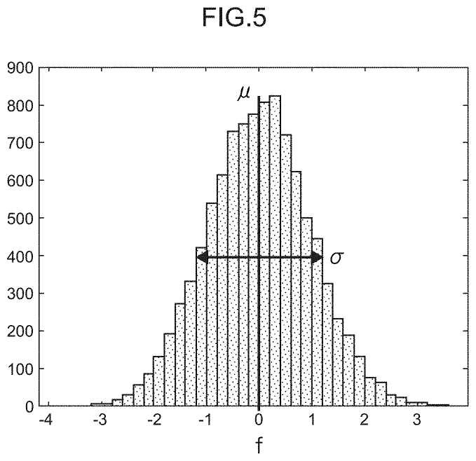

In the present exemplary embodiment, in order to find an ideal scoring distribution the score distribution creation section 58 creates a distribution of scores envisaging a normal distribution in which an average μ=approximately 60, a standard deviation σ is approximately 10, and a maximum score is 100, as in the normal distribution illustrated in FIG. 5.

Equation (1) below is employed as an equation to derive the evaluation score, in which w₀ and w₁ are coefficients that may be adjusted as desired.

$$score = {w}_{o} - {\sum }_{i} {w}_{i} \times \frac{{f}_{i} - {μ}_{i}}{{σ}_{i}} \qquad ( 1 )$$

i: sudden acceleration, sudden braking, sudden steering wheel operation, obstruction of pedestrian, tailgating
f: frequency (incidents/hour or incidents/kilometer)
μ: average frequency
σ: standard deviation

Since the evaluation score (score) may be expressed by Equation (2) below, if fᵢ are assumed to be independent, it becomes necessary to satisfy Equation (3) and Equation (4) below.

$$\begin{matrix}score = {w}_{o} - {\sum }_{i} {w}_{i} \times \frac{{f}_{i} - {μ}_{i}}{{σ}_{i}} \sim N ( 60 , {10}^{2} ) & ( 2 ) \\ {w}_{o} = 60 & ( 3 ) \\ {\sum }_{i} {w}_{i}^{2} = {10}^{2} & ( 4 )\end{matrix}$$

In the present exemplary embodiment, since, as an example, an evaluation score is computed for five actions (sudden acceleration, sudden braking, sudden steering wheel operation, obstruction of pedestrian, and tailgating), fᵢ are not expected to be independent. Accordingly, an adjustment is performed with Equation (5) below standing in for

$${w}_{i} = \sqrt{\frac{100}{5} + α} \sim 5 \qquad ( 5 )$$

Note that in order to set this coefficient appropriately, it is necessary to analyze driving data such as vehicle information and video image data for a wide range of drivers.

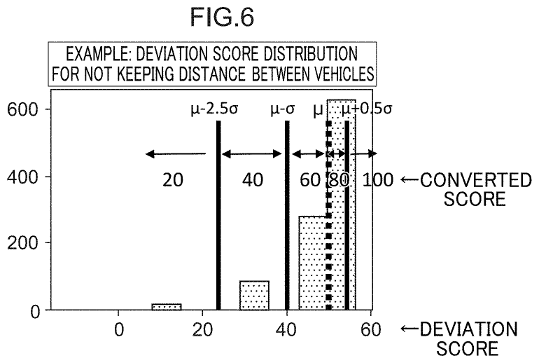

In the present exemplary embodiment, for example the evaluation result derivation section 60 employs Equation (6) below to derive a deviation score as the evaluation score, and in order to derive the converted score, the evaluation result derivation section 60 then applies a predetermined method to convert the evaluation score into five evaluation ranks based on the relationship illustrated in FIG. 6. Namely, FIG. 6 illustrates an example of a deviation score distribution for tailgating in which a converted score of 20 corresponds to an evaluation score below μ−2.5σ, a converted score of 40 corresponds to an evaluation score of from μ−2.5σ up to but not equal to μ−σ, a converted score of 60 corresponds to an evaluation score of from μ−σ up to but not equal to μ, a converted score of 80 corresponds to an evaluation score of from μ up to but not equal to μ+0.5σ, and a converted score of 100 corresponds to an evaluation score of μ+0.5σ or greater. Note that the predetermined method for deriving the converted score is not limited to the above. For example, a different number of ranks, such as three evaluation ranks or ten evaluation ranks, may be applied. Alternatively, the converted score may be derived by another method.

$${score}_{i} = 50 - 10 \times \frac{{f}_{i} - {μ}_{i}}{{σ}_{i}} \qquad ( 6 )$$

i: sudden acceleration, sudden braking, sudden steering wheel operation, obstruction of pedestrian, tailgating
f: frequency (incidents/hour or incidents/kilometer)
μ: average frequency
σ: standard deviation

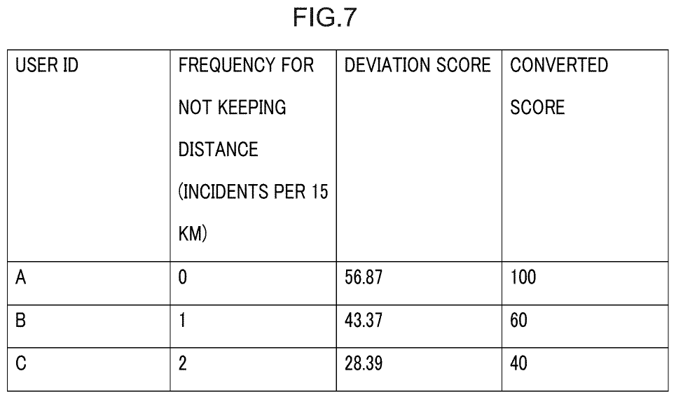

FIG. 7 illustrates an example of scores (deviation scores) and converted scores computed in this manner. FIG. 7 is a diagram illustrating an example of frequencies, deviation scores, and converted scores for tailgating for respective drivers.

In the example of FIG. 7, the driver with user ID A has a tailgating frequency of 0 incidents per 15 km, from which a deviation score of 56.87 is computed, to give a converted score of 100. The driver with user ID B has a tailgating frequency of 1 incident per 15 km, from which a deviation score of 43.37 is computed, to give a converted score of 60. The driver with user ID C has a tailgating frequency of 2 incidents per 15 km, from which a deviation score of 28.39 is computed, to give a converted score of 40.

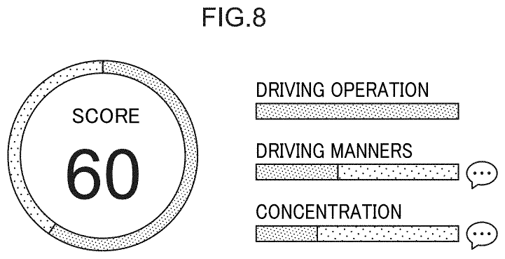

The converted score may, for example, be averaged from converted scores for each of the five categories of dangerous driving. Alternatively, in addition to the average for the five categories of dangerous driving, dangerous driving may also be classified in terms of driving operation, driving manners, concentration, and the like, and converted scores may be computed for each of these classifications and presented to the driver by the display device 28 as relative driving evaluation results for the driver, as illustrated in FIG. 8. Presentation to the driver may, for example, be performed by transmitting the driving evaluation result to an information processing terminal such as a mobile terminal or a personal computer of the driver, and displaying the driving evaluation result on a display device of this information processing terminal. FIG. 8 illustrates an example in which the average of the converted scores for the five categories of dangerous driving is 60, and an average of the converted scores for driving operation (including dangerous driving such as sudden acceleration, sudden braking, and sudden steering wheel operation), an average of the converted scores for driving manners (including dangerous driving such as obstruction of pedestrians and tailgating), and an average of the converted scores for concentration (including dangerous driving such as obstruction of pedestrians) are displayed as levels.

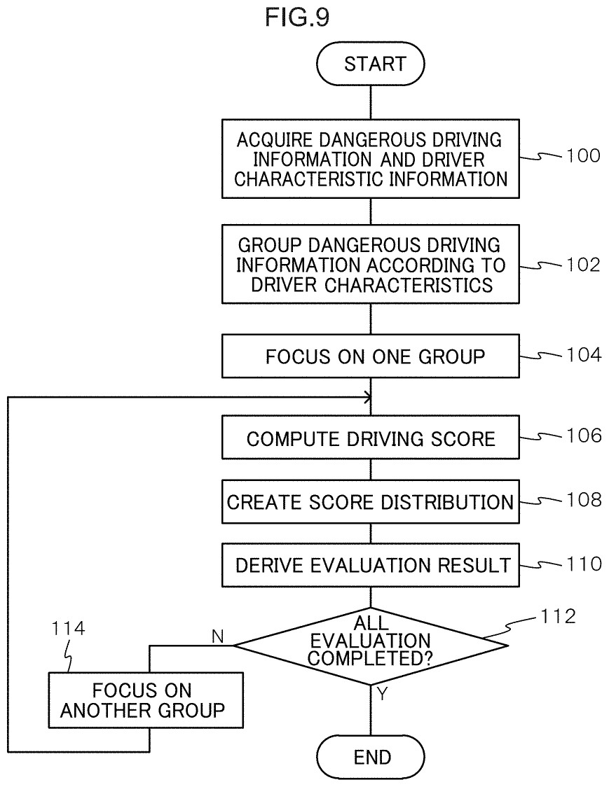

Next, detailed explanation follows regarding processing performed using the functionality of the dangerous driving evaluation section 50 of the central processing device 30 in the dangerous driving data gathering server 12 of the dangerous driving detection system 10 according to the present exemplary embodiment configured as described above. FIG. 9 is a flowchart illustrating an example of a flow of processing performed using the functionality of the dangerous driving evaluation section 50 of the central processing device 30 in the dangerous driving data gathering server 12 of the dangerous driving detection system 10 according to the present exemplary embodiment. Note that, for example, the processing of FIG. 9 is started at predetermined time intervals. Alternatively, the processing of FIG. 9 may be started at predetermined distance intervals, based on the vehicle information gathered from the onboard devices 16.

At step 100, the CPU 30A acquires dangerous driving information and driver characteristic information from the DB 38, and processing transitions to step 102. Namely, the acquisition section 52 acquires the dangerous driving information and the driver characteristic information that has been gathered by the dangerous driving information gathering section 46 and held in the DB 38.

At step 102, the CPU 30A groups the dangerous driving information according to the driver characteristics, and processing transitions to step 104. Namely, the grouping section 54 groups the dangerous driving information acquired by the acquisition section 52 based on the driver characteristic information according to driver characteristics including type of vehicle driven, age, gender, place of residence, years of driving experience, and the like.

At step 104, the CPU 30A focuses on one of the groups thus grouped, and processing transitions to step 106. Note that explanation follows regarding subsequent processing for an example in which driving evaluation is performed for all groups; however, there is no limitation thereto. For example, configuration may be made so as to focus on a group requested by the driver and perform driving evaluation for the requested group only.

At step 106, the CPU 30A computes a driving score, and processing transitions to step 108. Namely, the driving score computation section 56 computes a frequency of dangerous driving based on the dangerous driving information as a dangerous driving score for each driver for the focus target group out of the groups grouped by the grouping section 54. The frequency may be computed in terms of the number of dangerous driving incidents per unit distance traveled (frequency by distance) or the number of dangerous driving incidents per unit time (frequency by time).

At step 108, the CPU 30A creates a score distribution of the computed driving scores, and processing transitions to step 110. Namely, the score distribution creation section 58 creates a score distribution for the dangerous driving of all drivers for the focus target group out of the grouped groups.

At step 110, the CPU 30A derives an evaluation result for each driver, and processing transitions to step 112. Namely, the evaluation result derivation section 60 derives a deviation score as an evaluation score in which the scores of the respective drivers are evaluated with respect to the dangerous driving score distribution for all drivers for the focus target group. The evaluation result derivation section 60 further converts the derived evaluation score into a converted score in order to derive a relative driving evaluation result for each of the drivers.

At step 112, the CPU 30A determines whether or not all evaluation has been completed. This determination is determination as to whether or not evaluation results have been derived for all of the grouped groups. Processing transitions to step 114 in cases in which determination is negative, and the processing routine is ended in cases in which determination is affirmative.

At step 114, the CPU 30A focuses on another group, and processing returns to step 106 to repeat the processing described above.

The above processing is used to derive a driving evaluation result for each driver when drivers are grouped according to driver characteristics. This enables driving evaluation results to be derived in a manner that takes driver characteristics into consideration.

By deriving the evaluation scores for the respective drivers with respect to the dangerous driving score distribution, each driver is able to confirm their driving evaluation in relative terms. Deriving these evaluation scores enables scores to be calculated more easily than in cases in which dangerous driving levels are employed as dangerous driving scores. Moreover, employing the frequency of dangerous driving as a dangerous driving score enables any perception that the driving evaluation results are unfairly skewed according to the length of time spent driving or the distance driven to be suppressed in comparison to cases in which a total number of dangerous driving incidents or a dangerous driving level is employed as a dangerous driving score.

Note that in the exemplary embodiment described above, explanation has been given regarding an example in which driver characteristics are applied as supplementary information. However, there is no limitation thereto, and environmental characteristics when driving may be applied as supplementary information. Alternatively, both driver characteristics and environmental characteristics may be applied as supplementary information. In such cases, the grouping section 54 may perform grouping according to at least one type of supplementary information out of the driver characteristics or environmental characteristics. Applying environmental characteristics as supplementary information enables driving evaluation results to be derived that take into consideration the environment when driving.

Although explanation has been given regarding an example in which the dangerous driving data gathering server 12 is provided with the functionality of the dangerous driving evaluation section 50 in the exemplary embodiment described above, there is no limitation thereto. For example, the control sections 20 of the onboard devices 16 may be provided with the functionality of the dangerous driving evaluation section 50, and the processing illustrated in FIG. 9 may be performed by the onboard device 16. Alternatively, another dedicated server or the like for performing driving evaluation separately to the dangerous driving data gathering server 12 may be provided with the functionality of the dangerous driving evaluation section 50, and the processing illustrated in FIG. 9 may be performed thereby.

Although explanation has been given regarding an example in which the processing performed using the functionality of the dangerous driving evaluation section 50 of the central processing device 30 is software processing performed by executing a program in the exemplary embodiment described above, there is no limitation thereto. For example, this processing may be performed by hardware such as an application specific integrated circuit (ASIC) or a field-programmable gate array (FPGA). Alternatively, the processing may be performed by a combination of both software and hardware. In cases in which processing is performed by software, such a program may be distributed in a format stored in various storage media.

The present disclosure is not limited by the above description, and various modifications may be implemented within a range not departing from the spirit of the present disclosure.

An object of the present disclosure is to provide a driving evaluation device, a driving evaluation system, and a non-transitory computer-readable recording medium recorded with a driving evaluation program that are capable of outputting a driving evaluation result that takes into consideration at least one supplementary characteristic out of a driver characteristic or an environmental characteristic when driving.

A first aspect of the present disclosure is a driving evaluation device that includes: a memory; and a processor coupled to the memory. The processor is configured to: acquire dangerous driving detection results for a plurality of vehicles and characteristic information indicating supplementary characteristics for at least one of a driver characteristic or an environmental characteristic; and group the acquired dangerous driving detection results according to the characteristic information, and derive a relative driving evaluation result for each driver of the plurality of vehicles, based on the grouped detection results.

According to the first aspect of the present disclosure, dangerous driving detection results are acquired for plural vehicles, and the characteristic information representing supplementary characteristics is acquired for at least one out of a driver characteristic or an environmental characteristic.

The acquired detection results are grouped according to the characteristic information, and a relative driving evaluation result is derived for each driver based on the grouped detection results. Namely, deriving a driving evaluation result for each driver as grouped according to the characteristic information enables driving evaluation results that take into consideration supplementary characteristics to be derived.

A second aspect of the present disclosure is the driving evaluation device of the first aspect, wherein the processor is further configured to create a distribution of scores for dangerous driving of drivers of the plurality of vehicles and derive an evaluation score for each of the drivers with respect to the distribution of scores, as the relative driving evaluation result. This enables an evaluation score to be derived for each driver with respect to the dangerous driving score distribution, thus enabling a relative driving evaluation to be confirmed.

A third aspect of the present disclosure is the driving evaluation device of the first aspect, wherein the processor is further configured to create a distribution of scores for dangerous driving of drivers of the plurality of vehicles, derive an evaluation score for each of the drivers with respect to the distribution of scores, and derive a converted score as the relative driving evaluation result by converting the evaluation score using a predetermined method. Deriving an evaluation score for each driver with respect to the dangerous driving score distribution and then deriving a converted score enables a relative driving evaluation to be confirmed.

A fourth aspect of the present disclosure is the driving evaluation device of the second or third aspect, wherein the processor is further configured to create a frequency distribution for dangerous driving as the distribution of scores. This enables scores to be calculated more simply than in cases in which dangerous driving levels are employed as the dangerous driving scores.

A fifth aspect of the present disclosure is the driving evaluation device of the fourth aspect, wherein the processor is further configured to create, as the frequency distribution, a distribution of frequency for at least one of a frequency by distance per unit distance traveled or a frequency by time per unit time. This enables any perception that the driving evaluation results are unfairly skewed according to the length of time spent driving or the distance driven to be suppressed in comparison to cases in which a total number of dangerous driving incidents or a dangerous driving level is employed as a dangerous driving score.

A sixth aspect of the present disclosure is the driving evaluation device of the fifth aspect, wherein the processor is further configured to create, as the frequency distribution, each of a frequency distribution of the frequency by distance and a frequency distribution of the frequency by time, and to switch between which of the frequency distributions is created, according to circumstances. Switching between frequency by distance and frequency by time in accordance with circumstances enables a driving evaluation result better suited to the circumstances to be obtained.

A seventh aspect of the present disclosure is a driving evaluation system that includes: onboard devices, each including: an imaging device for provision to a vehicle, a first memory, a first processor coupled to the first memory, the first processor being configured to: detect dangerous driving based on image information related to a captured image captured by the imaging device, and vehicle information relating to the vehicle; and a driving evaluation device including: a second memory, a second processor coupled to the second memory, the second processor being configured to: acquire dangerous driving detection results from the onboard devices of a plurality of vehicles and acquire characteristic information indicating supplementary characteristics for at least one of a driver characteristic or an environmental characteristic, and group the acquired dangerous driving detection results according to the characteristic information, and derive a relative driving evaluation result for each driver of the plurality of vehicles based on the grouped detection results.

An eighth aspect of the present disclosure is a non-transitory computer-readable recording medium that records a program that is executable by a computer to perform a driving evaluation processing. The driving evaluation processing includes: acquiring dangerous driving detection results for a plurality of vehicles and characteristic information indicating supplementary characteristics for at least one of a driver characteristic or an environmental characteristic; and grouping the acquired dangerous driving detection results according to the characteristic information, and derive a relative driving evaluation result for each driver of the plurality of vehicles, based on the grouped detection results.

The present disclosure is capable of providing a driving evaluation device, a driving evaluation system, and a non-transitory computer-readable recording medium recorded with a driving evaluation program capable of outputting a driving evaluation result that takes into consideration at least one supplementary characteristic out of a driver characteristic or an environmental characteristic when driving.

What is claimed is:

1. A driving evaluation device comprising:
a memory; and
a processor coupled to the memory,
the processor being configured to:
acquire dangerous driving detection results for a plurality of vehicles and characteristic information indicating supplementary characteristics for at least one of a driver characteristic or an environmental characteristic; and
group the acquired dangerous driving detection results according to the characteristic information, and derive a relative driving evaluation result for each driver of the plurality of vehicles, based on the grouped detection results.

2. The driving evaluation device of claim 1, wherein the processor is further configured to create a distribution of scores for dangerous driving of drivers of the plurality of vehicles and derive an evaluation score for each of the drivers with respect to the distribution of scores, as the relative driving evaluation result.

3. The driving evaluation device of claim 1, wherein the processor is further configured to create a distribution of scores for dangerous driving of drivers of the plurality of vehicles, derive an evaluation score for each of the drivers with respect to the distribution of scores, and derive a converted score as the relative driving evaluation result by converting the evaluation score using a predetermined method.

4. The driving evaluation device of claim 2, wherein the processor is further configured to create a frequency distribution for dangerous driving as the distribution of scores.

5. The driving evaluation device of claim 4, wherein the processor is further configured to create, as the frequency distribution, a distribution of frequency for at least one of a frequency by distance per unit distance traveled or a frequency by time per unit time.

6. The driving evaluation device of claim 5, wherein the processor is further configured to create, as the frequency distribution, each of a frequency distribution of the frequency by distance and a frequency distribution of the frequency by time, and to switch between which of the frequency distributions is created, according to circumstances.

7. A driving evaluation system comprising:
onboard devices, each including:
an imaging device for provision to a vehicle,
a first memory,
a first processor coupled to the first memory, the first processor being configured to:
detect dangerous driving based on image information related to a captured image captured by the imaging device, and vehicle information relating to the vehicle; and
a driving evaluation device including:
a second memory,
a second processor coupled to the second memory, the second processor being configured to:
acquire dangerous driving detection results from the onboard devices of a plurality of vehicles and acquire characteristic information indicating supplementary characteristics for at least one of a driver characteristic or an environmental characteristic, and
group the acquired dangerous driving detection results according to the characteristic information, and derive a relative driving evaluation result for each driver of the plurality of vehicles based on the grouped detection results.

8. The driving evaluation system of claim 7, wherein the second processor is further configured to create a distribution of scores for dangerous driving of drivers of the plurality of vehicles and derive an evaluation score for each of the drivers with respect to the distribution of scores, as the relative driving evaluation result.

9. The driving evaluation system of claim 7, wherein the second processor is further configured to create a distribution of scores for dangerous driving of drivers of the plurality of vehicles, derive an evaluation score for each of the drivers with respect to the distribution of scores, and derive a converted score as the relative driving evaluation result by converting the evaluation score using a predetermined method.

10. The driving evaluation system of claim 8, wherein the second processor is further configured to create a frequency distribution for dangerous driving as the distribution of scores.

11. The driving evaluation system of claim 10, wherein the second processor is further configured to create, as the frequency distribution, a distribution of frequency for at least one of a frequency by distance per unit distance traveled or a frequency by time per unit time.

12. The driving evaluation device of claim 11, wherein the second processor is further configured to create, as the frequency distribution, each of a frequency distribution of the frequency by distance and a frequency distribution of the frequency by time, and to switch between which of the frequency distributions is created, according to circumstances.

13. A non-transitory computer-readable recording medium that records a program that is executable by a computer to perform a driving evaluation processing, the driving evaluation processing comprising:
acquiring dangerous driving detection results for a plurality of vehicles and characteristic information indicating supplementary characteristics for at least one of a driver characteristic or an environmental characteristic; and
grouping the acquired dangerous driving detection results according to the characteristic information, and derive a relative driving evaluation result for each driver of the plurality of vehicles, based on the grouped detection results.

14. The non-transitory computer-readable recording medium of claim 13, wherein the driving evaluation processing further comprises creating a distribution of scores for dangerous driving of drivers of the plurality of vehicles and deriving an evaluation score for each of the drivers with respect to the distribution of scores, as the relative driving evaluation result.

15. The non-transitory computer-readable recording medium of claim 13, wherein the driving evaluation processing further comprises creating a distribution of scores for dangerous driving of drivers of the plurality of vehicles, deriving an evaluation score for each of the drivers with respect to the distribution of scores, and deriving a converted score as the relative driving evaluation result by converting the evaluation score using a predetermined method.

16. The non-transitory computer-readable recording medium of claim 14, wherein the driving evaluation processing further comprises creating a frequency distribution for dangerous driving as the distribution of scores.

17. The non-transitory computer-readable recording medium of claim 16, wherein the driving evaluation processing further comprises creating, as the frequency distribution, a distribution of frequency for at least one of a frequency by distance per unit distance traveled or a frequency by time per unit time.

18. The non-transitory computer-readable recording medium of claim 17, wherein the driving evaluation processing further comprises creating, as the frequency distribution, each of a frequency distribution of the frequency by distance and a frequency distribution of the frequency by time, and switching between which of the frequency distributions is created, according to circumstances.
